(19) United States
(12) Patent Application Publication
(10) Pub. No.: US 2010/0174878 A1
(43) Pub. Date: Jul. 8, 2010

(54) Systems and Methods for Monitoring Archive Storage Condition and Preventing the Loss of Archived Data

(75) Inventors: Stephen Anthony Davis, Tucker, GA (US); Jesse Carroll Crawford, Atlanta, GA (US); James Hannon Pound, III, Lawrenceville, GA (US); Joseph Scott Saturday, Alpharetta, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Crawford Communications, Atlanta, GA (US)

(21) Appl. No.: 12/349,342

(22) Filed: Jan. 6, 2009

(51) Int. Cl. G06F 12/16; G06F 12/00

(52) U.S. Cl. 711/161; 711/E12.001; 711/E12.103

(57) ABSTRACT

Certain embodiments described herein provide methods and systems for archiving data over long periods of time, monitoring data archive storage condition, and preventing the loss of archived data. One exemplary embodiment provides a method of monitoring media storage that comprises receiving a piece of content for storage in a content archive system and storing the piece of content on a long-term storage medium of the content archive system. The method further comprises checking the long-term storage medium to determine a measure of condition of the long-term storage medium. This checking of the long-term storage medium occurs according to a checking policy, such as a spot checking policy. The method may also comprise automatically migrating the piece of content to another long-term storage medium when the measure of the condition of the long-term storage medium exceeds a threshold value.

### FIELD

Embodiments of the present disclosure relate generally to digitizing and archiving data, including rich media and data subject to infrequent access.

### BACKGROUND

Various techniques exist for digitizing and archiving information. Generally, these techniques have focused on archiving business data and other structured data, such as data from database tables, word processing documents, e-mails, and other types of text-based and character-based data that tends to be granular, repetitive, and stored in relatively small files. Archiving systems employ various management processes that use and often combine various types of disc-based and tape-based data storage. Some systems use hierarchical storage management (HSM) to repeatedly move data between different storage types depending on how frequently the data is accessed, i.e. up and down on a hierarchy of storage devices. For example, frequently-accessed content may be stored on fast disk storage, less frequently-accessed content may be stored on slower disk storage, and the least frequently-accessed content may be stored on data tape.

Because storage mechanisms degrade over time, archived data cannot remain on the same storage mechanism indefinitely. In many cases, archived data is accessed frequently enough that storage condition checks, e.g., bit error rate checks, performed during such data accesses can be used to monitor how the storage is degrading. Archival files of pictures, movies, audio recordings, graphics, and other rich media, and various other types of content, on the other hand, are often subject to infrequent access. The infrequent data access may not provide storage condition checks sufficient to statistically ensure that the storage has not degraded. And, thus, manual monitoring of the archived storage devices can be required to ensure that data contained on those devices is not lost. In addition, when digitizing content for long term preservation, it is often preferable to capture content at the highest available resolution. The resulting files can be extremely large and/or require extremely high bit-rates to enable real time playback. Lower quality copies, known as proxy files, are sometimes created to facilitate routine access to the content while the highest quality versions are archived, in some cases without being accessed or checked for years. For these reasons, the versions of highest quality are often most vulnerable to condition changes. Generally, while decreasing bandwidth and storage costs are making the digitization and archival of rich media more feasible, various hurdles have prevented the economical digitization and archiving of rich media.

### SUMMARY

Certain embodiments described herein provide methods and systems for archiving data over long periods of time, monitoring data archive storage condition, and preventing the loss of archived data. One exemplary embodiment provides a method of monitoring media storage that comprises receiving a piece of content for storage in a content archive system and storing the piece of content on a long-term storage medium of the content archive system. The method further comprises checking the long-term storage medium to determine a measure of condition of the long-term storage medium. This checking of the long-term storage medium occurs according to a checking policy, such as a spot checking policy. The method may also comprise automatically migrating the piece of content to another long-term storage medium when the measure of the condition of the long-term storage medium exceeds certain threshold values.

In other embodiments, a computer-readable medium (such as, for example, random access memory or a computer disk) comprises code for carrying out these methods.

These embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a system diagram illustrating an exemplary archive environment according to certain embodiments;

FIG. 2 is a flow chart illustrating a method of monitoring storage condition, according to certain embodiments; and

FIG. 3 is a flow chart illustrating another method of monitoring storage condition, according to certain embodiments.

### DETAILED DESCRIPTION

Certain embodiments described herein provide methods and systems for archiving data over long periods of time, monitoring data archive storage condition, and preventing the loss of archived data. Content storage can be monitored to prevent the loss of archived data in archives comprising large files that are subject to low transaction rates. Such data may comprise rich media content, including, but not limited to, pictures, movies, audio recordings, and graphics, that have been archived and are not accessed for years, decades, or even centuries. The monitoring and replication of archived data may be based on policies. One exemplary policy ensures that storage condition for a piece of media will be checked within a set or determined time period if the media storage is not otherwise checked. Other exemplary policies check media storage condition at time intervals determined based on the media's age and/or the results of prior media storage condition checks. Other exemplary policies spot check media storage at various locations within the media content (e.g., at the content's beginning, middle, and end) to monitor the condition of the media storage. Another exemplary policy restores data based on the results of a media storage condition check. For example, a piece of media may be automatically replicated on new media storage if the results of a media storage check exceed a threshold, e.g., if the bit error rate exceeds a given value. Various other policies and combinations of policies may also be used.

In certain embodiments, a checking policy is implemented to ensure that adequate storage condition checks occur to statistically ensure that storage has not degraded beyond recovery. Thus, in addition to condition checks that may occur when data is accessed under ordinary circumstances, additional storage condition checks may be performed according to the policy if those normal use checks are not providing adequate storage condition information. For example, a policy may recognize that a piece of media has not been accessed in 2 years and trigger a transaction (i.e., any request for data) to obtain a storage condition check for the piece of media. Information from storage condition checks can be used to monitor the condition of the storage over time. Such information can be used to identify when storage needs to be repaired, replaced, and/or when a storage checking policy needs to change. For example, if the storage condition check reveals that conditions are not good, the material or media may be automatically migrated over to new media storage. This may occur with or without user involvement. As another example, a storage condition check may reveal that the storage associated with a piece of media is in a condition that requires more frequent or more extensive monitoring.

### Exemplary Archive System

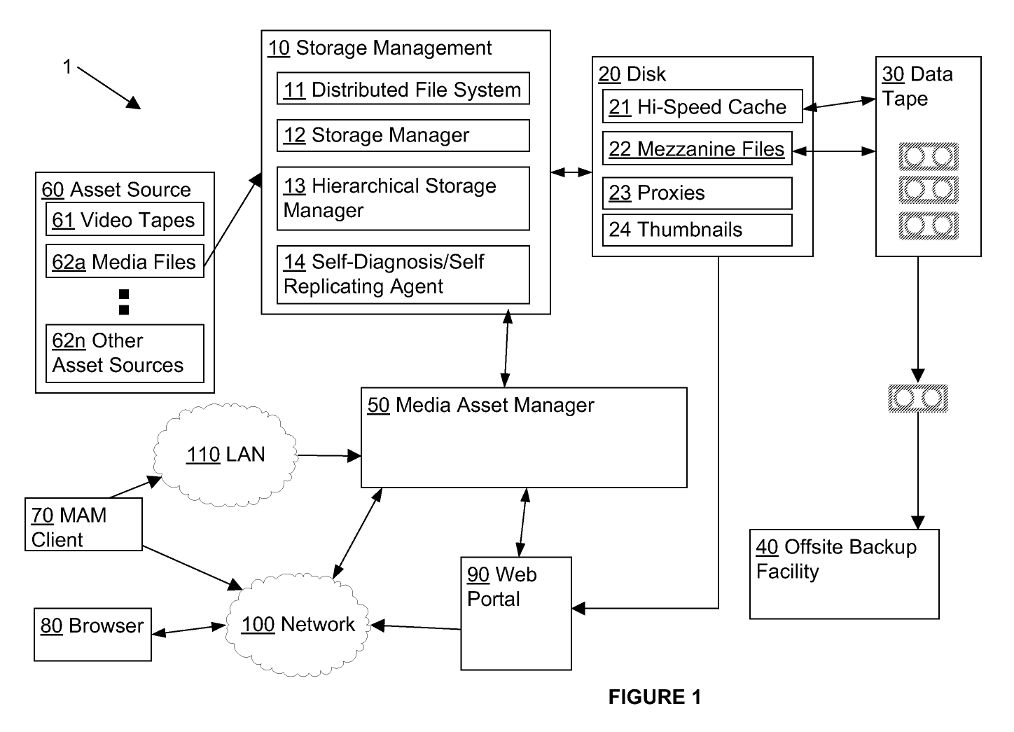

Referring now to the drawings in which like numerals indicate like elements throughout the several Figures, FIG. 1 is a system diagram illustrating an exemplary archive environment according to certain embodiments. Other embodiments may be utilized. The environment 1 shown in FIG. 1 comprises a wired or wireless network 100, a local area network (LAN) 110 and various computing components 10, 20, 30, 40, 50, 60, 70, 80. Applications and functions that execute on each of the computing components 10, 20, 30, 40, 50, 60, 70, 80 are shown as functional or storage components and may reside in memory on the respective devices. As is known to one of skill in the art, such applications may be resident in any suitable computer-readable medium and execute on any suitable processor. For example, the computing components 10, 20, 30, 40, 50, 60, 70, 80 shown each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

In FIG. 1, the archive system 1 archives content received from one or more asset sources such as the asset source 60. Such content may be stored at an asset source 60, for example on analog or digital video tapes 61, and may include media files 62a and other types of asset sources 62n. The storage management component 10 receives one or more pieces of content from an asset source 60 and archives the content for later use, backup, or other archiving purpose.

The storage management component 10 comprises a distributed file system 11 to allow files and folders to be managed across one or more storage devices, a storage manager component 12 for managing and monitoring the storage of pieces of media content, a hierarchical storage manager component 13 for optimizing or otherwise managing the use of content across different tiers of storage, and a self-diagnosis/self replicating agent 14 for monitoring the condition of storage media used to store pieces of content and initiating or otherwise facilitating the migration of content to different storage media at appropriate times.

The disk component 20 comprises digital storage for content that, in this embodiment, comprises one or more types of relatively fast and expensive digital, disk-based storage mediums. Disk 20 may comprise an array of hard disks or a collection of hard disk storage devices comprising a recording medium. A disk tier may comprise a high speed cache 21 to facilitate the encoding and playback of high bit rate content in and out of the system. Other portions or partitions of the disk tier may host mezzanine files 22, proxies 23, thumbnails 24, or other content (or derivations of archived content) that is made available for quick retrieval and use. For example, a piece of media content received from an asset source 60 at the storage management component 10 may be sent to the high speed cache 21 and transferred from there to long-term content storage such as data tape storage component 30. Various transfer checks may be associated with transferring content from its original source 60 to its destination on a data tape 30. In addition, prior to releasing or discarding the original content source 60, it is generally desirable to verify all the content was successfully recorded to the long-term content storage 30. For example a verify check may play back an entire tape and check all of the bits to make sure that all of the bits are successfully recorded. A verify can check for dropouts, high bit error rates, and chunks of missing data. The redundancy of the storage content typically makes identification of such problems relatively straightforward.

Once stored on a data tape 30, content is stored until it is accessed for use or diagnostics. While on the disk 20, the content is available for relatively quick retrieval and use. However, because disk storage is relatively expensive, content that has not been accessed in a while and/or content that is not expected to be accessed in the short term may be moved to a less expensive long-term storage medium such as to digital tape. If tape-stored data is needed for use, it can be restored, usually in a matter of minutes or hours, back to the active environment of the disk drives. Rich media content is a good candidate for tape-based or other low cost storage because the file sizes are large and because use and access of such content is in many cases very infrequent, minimizing the negatives associated with slow access speed. Content can also be exported to an offsite backup facility 40 to provide further assurance that, even if the data tape stored content is lost, an additional copy of the content will be available.

The various types of disk storage on disk 20 can provide a variety of functions and benefits. A mezzanine file 22 can also be created as a smaller and lesser quality version of a piece of content for everyday or frequent use, allowing the entire piece of media content (i.e., the high quality bit rate file) to be archived to long-term, cheaper storage. The high speed cache 21 can, among other things, provide a very temporary storage space used in the case where the archive system 1 is receiving content and transferring that content immediately to long-term storage. The content can move from the ingest environment through the storage software into the high speed cache 21 as a convenient way to get the content from one real time environment to another and then spool the data at the slower write speed of the tape or other long-term storage. The smaller mezzanine files 22, proxies 23 and the thumbnails 24 facilitate use of any archived content.

The hierarchical storage management (HSM) 13 monitors the occurrence and rate of access of content and determines when it is time to move content from one type of storage to another, for example from the disk storage to long-term tape storage. The HSM 13 system can use tier 1 storage to provide the fastest, most expensive, most on demand storage, tier 2 or near line storage as a slightly slower and cheaper form of disc storage, and tier 3 to provide the slowest and cheapest storage, such as long-term tape storage.

The storage management component 10 generally oversees the archiving and use of the media content and can track where content is stored. The storage management component 10 can provide an interface that allows a user to manage a large volume of stored content. The storage management component 10 may periodically verify data by doing a full verify pass or repack on the content on the tape. This may be impractical for archive systems involving huge amounts of data because of the significant system overhead and tape wear and tear resulting from periodic checking of the entire archive. Such checking would also be in addition to any regular access of the content.

Alternatively, the storage management component 10 may perform proactive spot checking according to policies to increase the checking efficiency. Such policies can be used to reduce or minimize the frequency of tape replacement, improve the recognition of storage problems, reduce needless checking, minimize wear and tear on a storage medium, and provide information about the condition of the storage medium. This process verifies the condition of the archival data which is very beneficial in many cases since archival content is typically irreplaceable. Verification can allow for intervention to migrate archival content before data is lost, but no sooner than necessary, providing both security and economy. Additionally, data retrieved from checking the storage medium can provide empirical knowledge of the medium storage degradation and about the physical characteristics of a given storage medium. In other words, it may provide real world test results of the durability of alternative storage options, allowing an archive service to select and use storage media more effectively.

A spot check need not look at all the data on a tape. A spot check can simply check portions of the storage medium, e.g., the beginning, middle and end of the data written on the tape, based on the assumption that the rest of the storage medium is not deteriorating at a different rate from the checked portions. Spot checking the beginning, middle and end of content may be, and generally is, faster than doing a full play of the tape and, thus, may create less wear on the tape.

One exemplary spot checking policy comprises decreasing time interval policies. Such a policy checks a piece of content more frequently as the content ages and/or as the content check results degrade. At some point, the policy specifies that the content is moved from the storage medium. For example, the policy may specify that the content is to be moved once the bit error rate exceeds a given threshold value. One exemplary decreasing time interval policy begins checking a piece of content at two year intervals and gradually reduces the time between checks, eventually leveling off with a check every six months, that is repeated until the bit error rate for the piece of content exceeds a given threshold value, at which time the policy specifies that the media content is automatically moved or otherwise migrated. A checking policy may, of course, vary based on the type of media and other factors. A policy may base the time between checks upon the results of one or more prior checks. Thus, if the system is seeing that bit error rates are going up, it can check the medium more frequently.

Certain aspects of the present disclosure relate to the automatic migration of content that does not necessarily involve direct user control or knowledge. Automation of the migration process may make it less prone to error, require less labor, and more certain to happen than a manual process that has to be monitored and manually handled.

Certain embodiments will involve a user being notified when a migration is required and/or when a migration has occurred. A storage management component of the system will also generally be aware of any migrations that occur so that if and when a piece of media is requested from the archive, the storage manager will know where the piece of media is located. For example, a storage manager may record that a particular file that has been archived for the last eight years is presently on a particular tape having a particular bar code identifier. The archive system may also use externalized tapes to house disaster recovery backup copies that are offline on a shelf in another physical location. The storage manger will generally also be aware of such backup copies as well. In cases where a piece of content is stored in two places, the system may perform intelligent migration, recognizing that it needs to replace the content in both locations.

A media asset manager component 50 and/or a web portal 90 may be included in an archive system to provide access to and control over the content archive system. For example, a user on a media asset manager client device 70 could access the media asset manager 50 through the LAN 110 or network 100 to retrieve a copy of an archived piece of content. As another example, the user may receive an update of the status of the monitoring of stored content, including for example information about recent condition checking on the storage media that holds the content. As another example, an archive administrator may access and control the archiving of content using the media asset manager 50. For example, the media asset manager 50 may notify the archive administrator of potential storage issues and allow an archive administrator to manually address such concerns or allow the administrator to customize parameters related to the automated diagnosis and migration of storage medium to avoid content loss, e.g., allowing the administrator to specify a bit rate error threshold that will trigger an automatic migration of a piece of content to another storage medium.

### Illustrative Methods of Monitoring Storage Condition

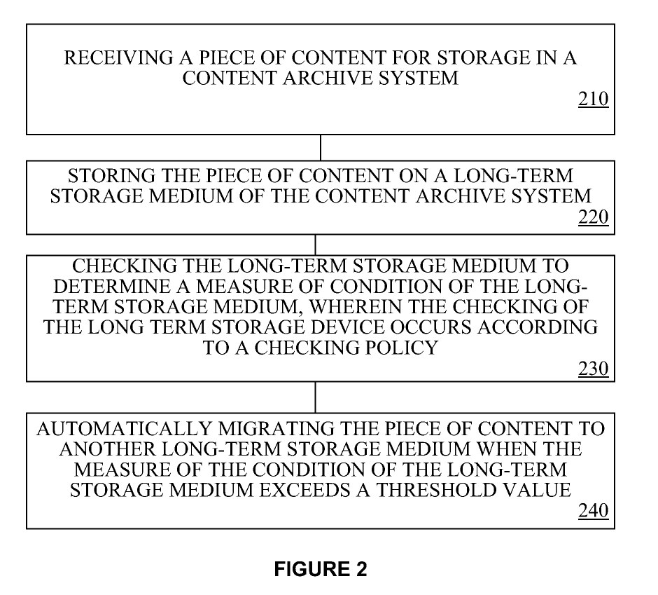

FIG. 2 is a flow chart illustrating a method of monitoring storage condition, according to certain embodiments. For purposes of illustration only, the elements of this method are described with respect to a particular implementation and with respect to exemplary components illustrated in FIG. 1. A variety of other implementations are also possible.

The method shown in FIG. 2 comprises receiving a piece of content for storage in a content archive system, as shown in block 210. For example, as shown in FIG. 1, an archive system 1 archives content received from one or more asset sources such as the asset source 60. Such content may be originally stored at an asset source 60, for example on analog or digital video tapes 61, and may include media files 62a and other types of asset sources 62n.

The method shown in FIG. 2 comprises storing the piece of content on a long-term storage medium of the content archive system, as shown in block 220. For example, as shown in FIG. 1, a storage management component 10 can receive one or more pieces of content from an asset source 60 and archive the content for later use, backup, or other archiving purpose.

The method shown in FIG. 2 comprises checking the long-term storage medium to determine a measure of condition of the long-term storage medium, as shown in block 230. The checking of the long-term storage medium occurs according to a checking policy. For example, the storage management component 10 shown in FIG. 1 could coordinate such checking. One exemplary checking policy comprises checking the beginning, middle, and end of the content on the long-term storage medium to determine measure of condition of the long-term storage medium. Another exemplary checking policy comprises checking the long-term storage medium at time intervals of decreasing duration for a series of successive checks. Another exemplary checking policy comprises ensuring that the long-term storage medium will be checked within a set time period if the media storage is not otherwise accessed. Yet other exemplary checking policies comprise checking the long-term storage medium at time intervals determined based on the age of the long-term storage medium and/or on the measure of condition of prior checking. A checking policy can be implemented in an attempt to ensure that adequate long-term storage condition checks occur to statistically ensure that the long-term storage medium has not degraded beyond recovery.

The method shown in FIG. 2 comprises automatically migrating the piece of content to another long-term storage medium when the measure of the condition of the long-term storage medium exceeds a threshold value, as shown in block 240. Alternatively, or in addition, a matrix of parameters may be evaluated, initiating migration as multiple indicators approach threshold values. For example, self-diagnosis/self-replicating agent 14 of the storage management component 10 shown in FIG. 1 could coordinate such automatic migration.

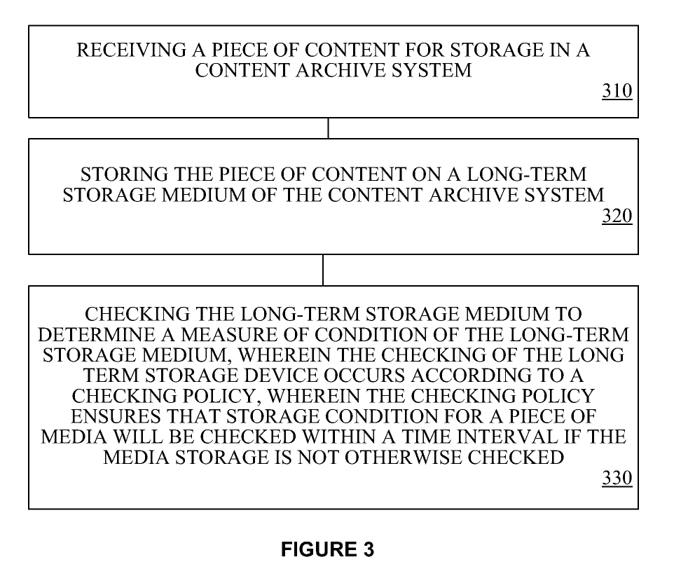

FIG. 3 is a flow chart illustrating a method of monitoring storage condition, according to certain embodiments. For purposes of illustration only, the elements of this method are described with respect to a particular implementation and with respect to exemplary components illustrated in FIG. 1. A variety of other implementations are also possible.

The method shown in FIG. 3 comprises receiving a piece of content for storage in a content archive system, as shown in block 310. For example, as shown in FIG. 1, an archive system 1 archives content received from one or more asset sources such as the asset source 60. Such content may be originally stored at an asset source 60, for example on analog or digital video tapes 61, and may include media files 62a and other types of asset sources 62n.

The method shown in FIG. 3 comprises storing the piece of content on a long-term storage medium of the content archive system, as shown in block 230. For example, as shown in FIG. 1, a storage management component 10 can receive one or more pieces of content from an asset source 60 and archive the content for later use, backup, or other archiving purpose.

The method shown in FIG. 3 comprises checking the long-term storage medium to determine a measure of condition of the long-term storage medium, as shown in block 230. For example, the storage management component 10 shown in FIG. 1 could coordinate such checking. The checking of the long-term storage medium occurs according to a specific checking policy implemented to ensure that the long-term storage medium will be checked within a set time period if the media storage is not otherwise accessed. This may involve monitoring access to a given piece of media so that a time since last access can be determined and used to determine whether a new check needs to be initiated. Generally, the time since the last check occurred can be compared to a time interval specifying a checking time interval for the piece of media, such that if the time since last check exceeds the checking time interval, a self diagnosis/self replicating component or other process can automatically initiate a new check or signal an administrator that a new check may be appropriate, given the checking policy and history of access to the piece of media.

### General

Certain embodiments relate to methods and systems for archiving data over long periods of time, monitoring data archive storage condition, and preventing the loss of archived data. These are merely illustrative. In short, the archiving, storage monitoring techniques, and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown as functional or storage components on the respective devices. As is known to one of skill in the art, such applications may be resident in any suitable computer-readable medium and execute on any suitable processor. For example, computing and media consuming devices each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

While the network 100 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a remote control, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs.

That which is claimed:

1. A method of monitoring storage condition, the method comprising:
receiving a piece of content for storage in a content archive system;
storing the piece of content on a long-term storage medium of the content archive system;
checking the long-term storage medium to determine a measure of condition of the long-term storage medium, wherein the checking of the long-term storage medium occurs according to a checking policy; and
automatically migrating the piece of content to another long-term storage medium when the measure of the condition of the long-term storage medium exceeds a threshold value.

2. The method of claim 1, wherein the checking policy comprises checking the beginning, middle, and end of the content on the long-term storage medium to determine measure of condition of the long-term storage medium.

3. The method of claim 1, wherein the checking policy comprises checking the long-term storage medium at time intervals of decreasing duration for a series of successive checks.

4. The method of claim 1, wherein the checking policy comprises ensuring that the long-term storage medium will be checked within a set time period if the media storage is not otherwise checked.

5. The method of claim 1, wherein the checking policy comprises checking the long-term storage medium at time intervals determined based on an age of the long-term storage medium.

6. The method of claim 1, wherein the checking policy comprises checking the long-term storage medium at time intervals determined based on the measure of condition of prior checking.

7. The method of claim 1, wherein the checking policy ensures that adequate long-term storage condition checks occur to statistically ensure that the long-term storage medium has not degraded beyond recovery.

8. A method of monitoring storage condition, the method comprising:
receiving a piece of content for storage in a content archive system;
storing the piece of content on a long-term storage medium of the content archive system;
checking the long-term storage medium to determine a measure of condition of the long-term storage medium, wherein the checking of the long-term storage medium occurs according to a checking policy, wherein the checking policy ensures that storage condition for a piece of media will be checked within a time interval if the media storage is not otherwise checked.

9. The method of claim 8, wherein the checking policy comprises checking the beginning, middle, and end of the content on the long-term storage medium to determine measure of condition of the long-term storage medium.

10. The method of claim 8, wherein the checking policy comprises checking the long-term storage medium at time intervals of decreasing duration for a series of successive checks.

11. The method of claim 8, wherein the checking policy comprises ensuring that adequate long-term storage condition checks occur to statistically ensure that the long-term storage medium has not degraded beyond recovery.

12. The method of claim 8, wherein the checking policy comprises checking the long-term storage medium at time intervals determined based on an age of long-term storage medium.

13. The method of claim 8, wherein the checking policy comprises checking the long-term storage medium at time intervals determined based on the measure of condition of prior checking.

14. The method of claim 8 further comprising automatically migrating the piece of content to another long-term storage medium when the measure of the condition of the long-term storage medium exceeds a threshold value.

15. The method of claim 8, wherein the long-term storage medium is a digital tape storage medium.

16. The method of claim 8, wherein the measure of condition of the long-term storage medium is a bit error rate.

17. A content archive system comprising:
a long-term storage medium component for receiving a piece of content for storage and storing the piece of content;
a storage management component for managing the storing, retrieving, and migrating of the piece of content; and
a diagnosis component for checking the long-term storage medium to determine a measure of condition of the long-term storage medium, wherein the checking of the long-term storage medium occurs according to a checking policy, wherein the diagnosis component initiates migration of the piece of content to another long-term storage medium when the measure of the condition of the long-term storage medium exceeds a threshold value.

18. The system of claim 17, wherein the checking policy ensures that adequate long-term storage condition checks occur to statistically ensure that the long-term storage medium has not degraded beyond recovery.

19. A computer-readable medium on which is encoded program code, the program code comprising:
program code for receiving a piece of content for storage in a content archive system;
program code for storing the piece of content on a long-term storage medium of the content archive system;
program code for checking the long-term storage medium to determine a measure of condition of the long-term storage medium, wherein the checking of the long-term storage medium occurs according to a checking policy; and
program code for automatically migrating the piece of content to another long-term storage medium when the measure of the condition of the long-term storage medium exceeds a threshold value.

20. A computer-readable medium on which is encoded program code, the program code comprising:
program code for receiving a piece of content for storage in a content archive system;
program code for storing the piece of content on a long-term storage medium of the content archive system; and
program code for checking the long-term storage medium to determine a measure of condition of the long-term storage medium, wherein the checking of the long-term storage medium occurs according to a checking policy, wherein the checking policy ensures that storage condition for a piece of media will be checked within a set time period if the media storage is not otherwise checked.
